(19) United States
(12) Patent Application Publication
(10) Pub. No.: US 2016/0255447 A1
(43) Pub. Date: Sep. 1, 2016

(54) Method for Fitting Hearing Aid in Individual User Environment-Adapted Scheme, and Recording Medium for Same

(71) Applicants: BIOSOUNDLAB CO., LTD., Gyeonggi-do (KR); SAMSUNG LIFE PUBLIC WELFARE FOUNDATION, Seoul (KR)

(72) Inventors: Moon-soo KIM, Seoul (KR); Yang-sun CHO, Seoul (KR)

(21) Appl. No.: 14/786,434

(22) PCT Filed: Apr. 16, 2014
(86) PCT No.: PCT/KR2014/003293

§ 371 Date: May 3, 2016

(30) Foreign Application Priority Data
Apr. 24, 2013 (KR) 10-2013-0045211

(51) Int. Cl. H04R 25/00

(52) U.S. Cl. CPC H04R 25/70; H04R 25/50; H04R 2225/39; H04R 2225/41; H04R 2225/55

(57) ABSTRACT

A method for fitting a hearing aid as customized to an individual environmental of a user comprises storing various environmental parameter correcting data in accordance of effects to a hearing capacity of each different environmental in a database of a mobile device; setting a personal hearing data; searching an environmental parameter correcting data matching a use environmental from the database when a hearing aid is located in the use environmental; and correcting a personal fitting data by the searched environmental parameter correcting data.

### FIELD OF THE INVENTION

The present invention relates to a method for fitting a hearing aid as customized to an individual environmental of a user and a medium for storing the same, in particular relates to a method for fitting a hearing aid capable of correcting a difference of an each environmental of use and a Medium for Storing the Same.

### BACKGROUND OF THE INVENTION

In general, a hearing aid should be fitted for use of a person having a hearing impairment, and the hearing capability of the person should be investigated in a medical center or an institute for treating a hearing impairment to apply a hearing threshold value to the hearing aid. In an advanced hearing aid, it is possible for fitting the hearing aid in order to apply each noise generated in a bustle place and a quiet place to the hearing aid differently. In the case of the known hearing, even though a noisy environmental is considered in a course of fitting, one fitting value is determined for the hearing aid finally. Hence, one voice signal based on the fitting value and combined in accordance of various environmental of use is transmitted to the person, when the hearing aid is used in actual environmental. That is, the fitted voice signal is not based on different environmental, but is based on a complex environmental. And the fitting of the hearing aid may be not suitable for the person depending on an environmental of use.

Korean patent publication number 2011-0079846 discloses a method for fitting a hearing aid based on a personal experience in an actual environmental of use. And Korean patent publication number 2012-0088879 discloses other method for fitting a hearing aid based on an actual hearing impairment and a personal tendency to a noisy environmental to apply different compression ratios gain according to personal characteristics.

In the above-mentioned known fitting methods, various environmental of use are considered in a course of fitting, but the known methods have some defect that the final fitting value is one. In a meanwhile, it is difficult for a user of a hearing aid to select a fitting data depending on an actual environment. If a plural of fitting data is provided, a person having a hearing impairment, he may select a fitting data of his hearing aid depending on a noisy place where he is. In such case, the fitting data may be selected on detecting various noises generated in the place by software installed in the hearing aid.

### OBJECT OF THE PRESENT INVENTION

An object of the present invention is to provide a method for fitting a hearing aid to detect an effect of various noises generated in his actual environmental of use and being capable of selecting a fitting data suitable for the noisy environmental.

Other object of the present invention is to provide a medium to process a fitting of a hearing aid in a system having a database in which various fitting data in accordance of different environmental are store, a mobile device connected to the database and the hearing aid to communicate the mobile device.

### SUMMARY OF THE INVENTION

In an aspect of the present invention, a method for fitting a hearing aid as customized to an individual environmental of a user comprises: storing various environmental parameter correcting data in accordance of effects to a hearing capacity of each different environmental in a database of a mobile device; setting a personal hearing data; searching an environmental parameter correcting data matching a use environmental from the database when a hearing aid is located in the use environmental; and correcting a personal fitting data by the searched environmental parameter correcting data.

In other aspect of the present invention, the environmental parameter correcting data comprises a standard data, wherein the standard data is generated by an average gain setting obtained from a data accumulated through each personal selection in various noisy environments and based on the individual difference.

In another aspect of the present invention, a system for applying a fitting data correcting a hearing impairment comprises a device for correcting a hearing; a mobile device to communicate with the device; a means for determining a parameter to effect hearing capacity in an audible signal input from a use environmental, wherein the audible signal is input into the mobile device; and a hearing server to select a environmental parameter correcting data based on the parameter transmitted from the means and to return to the mobile device, wherein the hearing server comprises a database storing personal data and a standard data, and the personal data are generated based on a selection of a user in a noisy environmental.

In still another aspect of the present invention, a storing medium capable of processing a method for correcting a fitting data may be provided, and the method comprises setting a personal hearing data; searching an environmental parameter correcting data matching a use environmental from the database when a hearing aid is located in the use environmental; and correcting a personal fitting data by the searched environmental parameter correcting data, wherein the database is storing in the medium or a server capable of communicating with the mobile device.

### BRIEF DESCRIPTION OF THE DRAWINGS

FIG. 1 shows an embodiment of a fitting method in accordance of the present invention.

FIG. 2 shows an embodiment generating an environmental parameter correcting data in according to the present invention.

FIG. 3 shows an embodiment of a process to correcting a personal hearing data depending on an environment of a user in according to the present invention.

FIG. 4 shows an embodiment of a system for applying a fitting method in according to the present invention.

### DETAILED DESCRIPTION

In the following description numerous specific details are set forth in order to provide a thorough understanding of the invention. However, one skilled in the art would recognize that the invention might be practiced without these specific details. In other instances, well known methods, procedures, and/or components have not been described in detail so as not to unnecessarily obscure aspects of the invention.

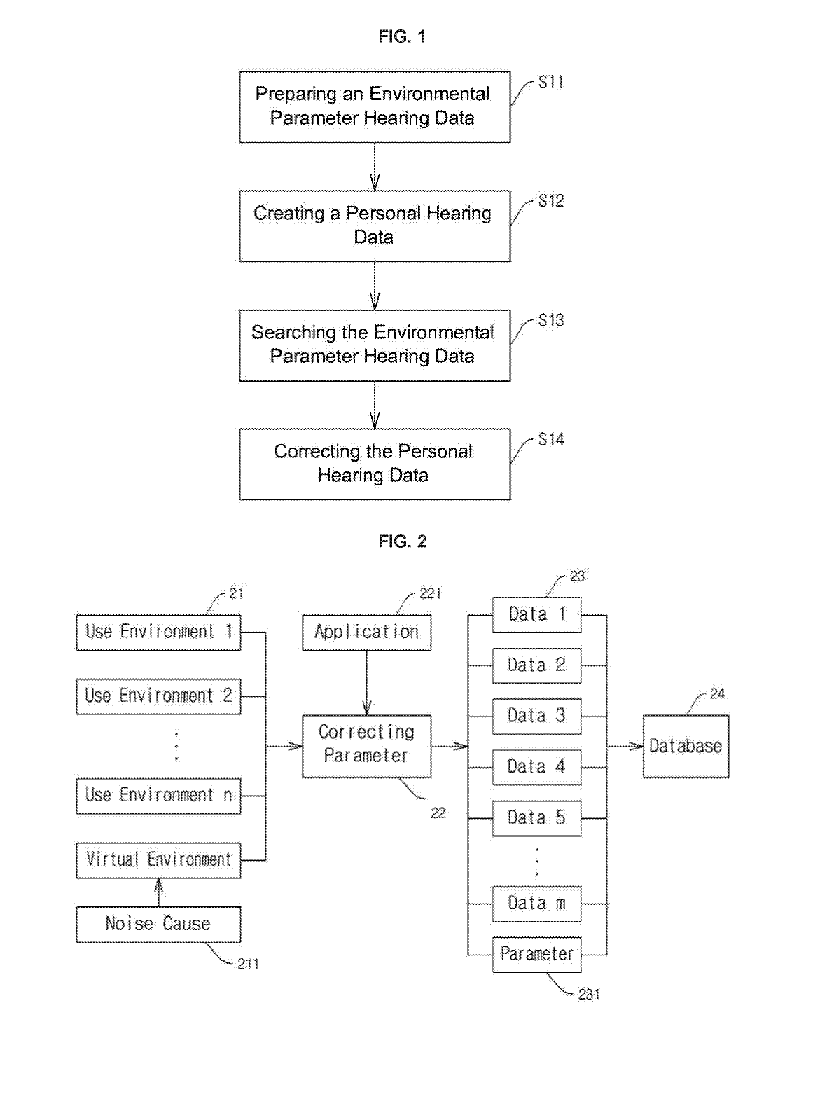

FIG. 1 shows an embodiment of a fitting method in accordance of the present invention.

Referring to FIG. 1, a method for fitting a hearing aid comprises storing various environmental parameter correcting data in accordance of effects to a hearing capacity of each different environmental in a database of a mobile device S11; setting a personal hearing data S12; searching an environmental parameter correcting data matching a use environmental from the database when a hearing aid is located in the use environmental S13; and correcting a personal fitting data by the searched environmental parameter correcting data S14.

The method for fitting a hearing aid may apply all the hearing devices including a hearing device. An environmental condition means all the sounds generated from a place where the hearing aid is located actually or is supposed to be located and to affect to a hearing capacity. The environmental condition may be an actual sound generated in some environment of a user or an expected sound generated in an imaginary environment of the user. In one environmental condition, a plural of environmental parameter hearing data may be produced. The plural of environmental parameter hearing data are caused from an effect difference of a user in the environment. The environmental condition may comprise an actual condition and a virtual condition, and the environmental parameter hearing data of the actual condition may comprise a sound which is generated in various places in a course of an actual life and may affect the hearing capacity. On the other hand, the environmental parameter hearing data of the virtual condition may be made from a presumption that the user can be located in sonic noisy environment which is in usual life. Both of the environmental parameter hearing data from the actual condition and the virtual condition cannot be differentiated actually and may be applied to a process for correcting a hearing data of the user or for correcting a data of an audiogram.

The environmental parameter hearing data may be made based on different frequency band, amplitude, spectrum, wave form, transferring way, interfering form and the like. A method for creating an environmental parameter hearing data will be described in following.

When an environmental parameter hearing data is produced, the hearing data may be stored in a database S11, and the database may be made in an external server or a mobile device for example a smart phone. When the database is installed in the external server, an application may be installed in the mobile device for communicating between the external server and the mobile device in order to transmit or receive the environmental parameter hearing date. Alternatively, the mobile device may access to the database via interact. And also, the environmental parameter hearing data can be received in a hearing aid or an hearing compensating device using data communication with the mobile device. When the database is made in the mobile device such as the smart phone, the hearing aid or the hearing compensating device may have a near field communicating chip or a Bluetooth chip for communicating with the mobile device.

When the environmental parameter is made and stored S11, a personal hearing data may be produced S12. The personal hearing data can be made in advance. And a plural of personal hearing data can be made as in a form of audiogram by using an audiometer or the like, or made directly by the user. The plural of personal data may comprise a hearing data in case of conversation with one, a hearing data in case of conversation with many people, a hearing data for hearing an audible device such as a radio or television or a hearing data for applying an individual algorism related to an hearing aid. But the plural of hearing data has no corrected value by an environmental parameter. The personal hearing data has a corrected value based on the amplitude of sound and a frequency band of sound, and no corrected value based on an effect of audible sound due to an environmental parameter. And also, the personal hearing data may relate mainly to the physical impairment of an ear. The hearing data may be obtained from an application installed in the mobile device of the user. In such case, the personal hearing data may be produced in a silent environment where there is no noise. The personal hearing data may be obtained through various ways. And the produced personal hearing data may be applied to a hearing aid with or without a correction by an environmental parameter hearing and may be stored in the database. If a plural of personal hearing data are produced, one personal hearing data selected from them may be applied to the hearing aid for fitting according to a choice of the user or an environmental condition. The selected personal hearing data may be applied after correcting by an environmental parameter hearing data.

If the environmental parameter correcting data and the personal hearing data are stored after produced, an environmental condition may be selected by the user or by a process according to a software program. And then, the personal hearing data may be corrected by the environmental parameter hearing data according to a selected environmental condition to apply to the hearing aid.

At first, an environmental condition has to be selected by the user or by a process according to a software program in order to apply the environmental parameter hearing data. If the environmental condition may be input into a mobile device after being selected, an environmental parameter hearing data which matches to the input environmental condition may be searched from a predetermined environmental parameter hearing data by a software application installed in the mobile device S13. If the environmental parameter hearing data matching to the input environmental condition is selected after searching, then the personal hearing data may be corrected by the environmental parameter hearing data to apply to the hearing aid. Then, the hearing aid may be utilized by the user in the condition of being corrected by the environmental parameter hearing data. If the environmental condition is changed in a course of using the hearing aid, the user may select other environmental parameter hearing data. Alternatively, the environmental condition may be input into the hearing aid or the mobile device at a predetermined period. Then the alternation of the environmental condition may be judged by the software program. If the environmental condition had been changed, other environmental parameter hearing data may be searched to correct the personal hearing data.

FIG. 2 shows an embodiment generating an environmental parameter correcting data in according to the present invention.

Referring to FIG. 2, the environmental parameter correcting data may be produced from each environmental condition 21. The environmental condition 21 may be an actual environment that the user experiences. And the environmental condition 21 may comprise a virtual environment that the user can experience in future or a virtual environment having an environmental parameter that affects the hearing capacity of the user. The environmental condition 21 may be one or the more, and may be classified by each noise cause 211. Each noise cause 211 having a different frequency or amplitude may be classed as a different environmental condition 21. If the environmental condition 21 is classed according to the noise cause 211, a correcting parameter 222 may be extracted by an extracting application 221. The extracting application 221 may analyze an effect of the hearing capacity caused by a noise generated in the environmental condition 21 based on the frequency band or amplitude band. And the extracting application 221 may determine a band or value corrected in the personal hearing data. Alternatively, the extracting application 221 may extract a correcting parameter 22 in the personal hearing data. The correcting parameter 22 may be determined based on the personal hearing data and the noise cause 211. For example, in some environmental condition 21, the noise cause 211 may classify a noise as a peripheral man, a vehicle noise, a natural noise caused by wind or rain, a noise of working place or a noise caused from a construction or the like. Then a frequency or amplitude property of each noise can be analyzed. Then the correcting parameter 22 can be determined depending on the frequency property, the amplitude property or the orientation of the noise. Therefore, the correcting parameter may be at least one, and the noise cause 211 relates to the correcting parameter 22. And finally, the environmental condition 21 may be classified according to the correcting parameter 22.

The Extracting application 221 may be stored in the mobile device such as a smart phone or an external server. The environmental condition 21 may be input into the hearing aid or the mobile device such as a smart phone to transmit to the mobile device or the external server. The environmental condition 21 should be input in spot of use directly to apply to the personal hearing data. Therefore, it is convenient that the extracting application 221 is installed in the mobile device.

If the correcting parameter 22 is extracted from the environmental condition 21 by the extracting application 221, then the environmental parameter correcting data 23 may be produced. The environmental parameter correcting data 23 may be classified according to the parameter 231 determined by the correcting parameter 22 to store. In general, one environmental parameter correcting data 23 may be produced in one environmental condition 21, but two or more environmental parameter correcting data 23 may be produced in one environmental condition 21. On the other hand, the environmental parameter correcting data 23 may be not produced, if the present environmental condition 21 is the same or similar as the previous one.

The environmental parameter correcting data 23 may be classified by the parameter 231. The parameter 231 may comprise a frequency band, amplitude, an orientation, a wave form, a dissipating property, a generating property and the like. if a value of each parameter is determined, then the identifying field, classifying field and parameter property field may be determined. Then at least one environmental parameter correcting data 23 may be produced according to each environmental condition 21. If the parameter property field is the same or similar to the previous one, the environmental parameter correcting data 23 may be not produced.

The environmental parameter correcting data 23 may be produced based on a degree of, hearing capacity in which the use experiences. Specifically, an environmental noise generated in areal environment of the user may be input through a microphone equipped in the mobile device of the user or via the hearing aid. And an environmental parameter may be extracted by the extracting application to apply to the personal hearing data. Then the hearing aid may operate in the ears of the user using the corrected personal hearing data. The user may regulate the hearing aid with a volume button, a compression ratio button and a frequency changing button and the like to find out a suitable hearing data for the user. The particulars of the user selection may be stored in the mobile device. Then the correcting parameter which affects the hearing capacity of the user may be extracted by the extracting application under the selected real condition, if necessary, the procedure may be iterated repeatedly. Then the parameter according to the noise cause 211 may be determined finally to store in the mobile device or the external server as a personal hearing data. The environmental parameter correcting data 23 produced through the above method has an advantage that the personal hearing data is produced based on the real audible experience of the user. On the other hand, the accumulation of the environmental parameter correcting data 23 through the method may make a standard data which can be applied to some user under the same or similar condition be created. In general, each user may be under a similar environmental condition, and each user may have common correcting parameter related to the noise cause 211 except for personal peculiarity. The accumulation of the environmental parameter correcting data may make the common correcting parameter be extracted. And a gain which is preferable and advantageous to each user may be set based on the extracted common correcting parameter under the particular environmental condition. And the setting of the common gain may be a standard data. On the other hand, the correcting parameter 22 according to the personal peculiarity may be a personal data. Afterward, the correcting parameter of the standard data and the personal correcting parameter of the personal data may be applied together to produce the most suitable fitting data. And also, the generation or regeneration of the standard data may develop an adaptive fitting algorithm according to a noisy environment.

The produced environmental parameter correcting data 23 may he stored in the database 24 which is installed in the mobile device or the external server.

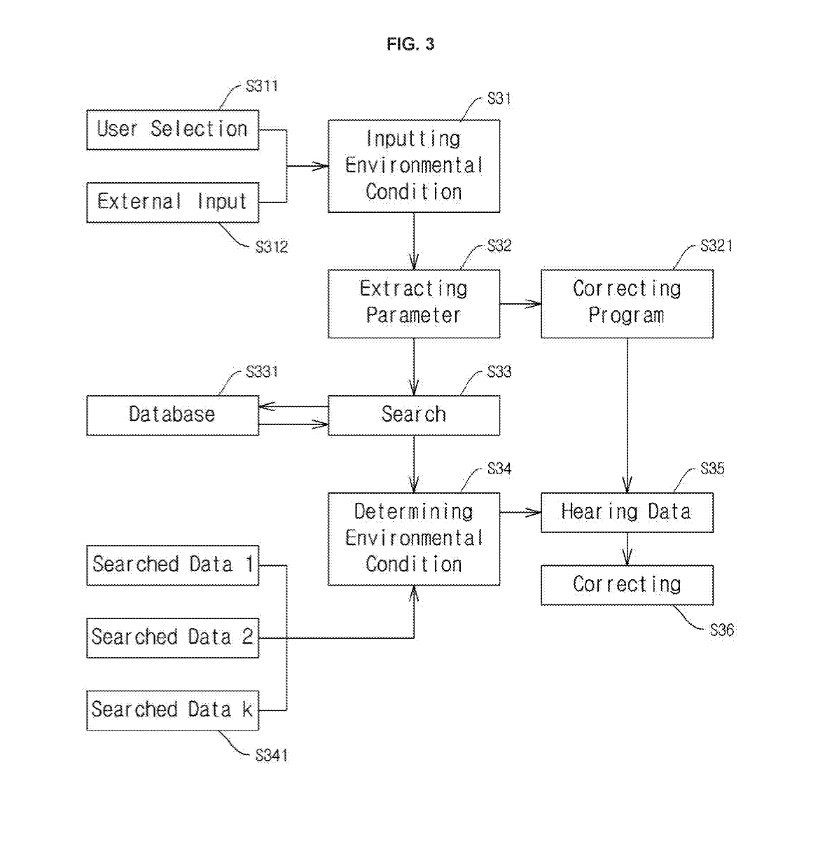

FIG. 3 shows an embodiment of a process to correcting a personal hearing data depending on an environment of a user in according to the present invention.

Referring to FIG. 3, an environmental condition may be input in a hearing aid or a mobile device for correcting hearing capacity S31. The environmental condition may be input through two ways. For example, the environmental condition may be input by the selection of the user S311, or the environmental condition may be input through a microphone equipped in the hearing device or the mobile device S312. The user may select with a selection button made in a form of menu, and the selection button may be displaced at the hearing aid or the mobile device. The environmental condition may be input periodically through the microphone or by the selection of the user. If the environmental condition is input S31, then a parameter may he extracted from the environmental condition, for example, by an extracting application. Alternatively the parameter may be extracted by the real time reaction of the user. Then the extracted parameter may be searched in a database S331 installed in the mobile device or the external server S33. The searching may mean a determination of matching degree. For example, if the parameter is frequency band, the similarity of peak frequency may be compared with data in the database. If the difference of the peak frequency lies in 0 to 10 Hz, the parameter may be considered as a similar environmental condition. On the other hand, if the number of parameters to be searched is the amount of ten and at least eight parameters are similar, the input environmental condition can be considered as the environmental condition stored in the database. According to the above procedure, a plural of environmental parameter correcting data can be produced S341, and k numbers of environmental parameter correcting data may be created. Then the priority of the environmental parameter correcting data may be set to determine the environmental condition where the hearing aid is located presently S34.

Alternatively, if the parameter is extracted S32, a correcting value may be determined based on the extracted parameter by a correcting software program S321. The correcting software program may be installed in the mobile device.

The correcting result may be applied to a personal hearing data S35, and the hearing aid may operate according to the corrected hearing data S36. On the other hand, the environment condition may be input periodically into the hearing aid or the mobile device S312. If there is a judgment that the environment condition is changed significantly, the process mentioned above may be repeated.

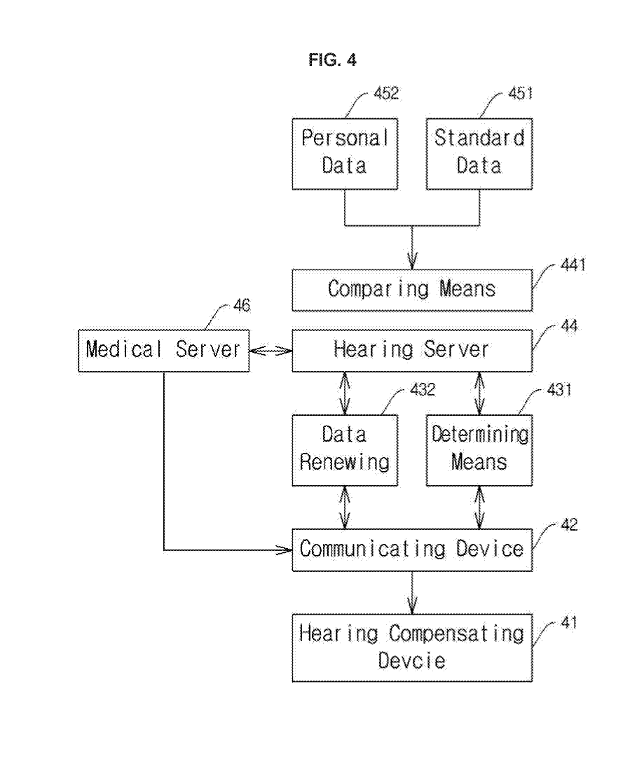

FIG. 4 shows an embodiment of a system for applying a fitting method in according to the present invention.

Referring to FIG. 4, a hearing compensating device 41 such as a hearing aid or an earphone may communicate with a communicating device 42. The device 41 may have a communicating chip for near field communication, Wi-Fi communication or Bluetooth communication. Alternatively, the device 41 may be connected to the communicating device 42 by a wire or cable. The communicating device 42 may have a microphone for inputting an external environmental condition which may be input by a selection of a user. The communicating device 42 may be a smart phone capable of being connected to the device 41. The user can display a menu window in the smart phone to input the environmental condition. The environmental condition input into the communicating device 42 may be converted into an environmental correcting parameter data by an environment determining means 431 such as an extracting application. The environment determining means 431 may be stored in the communicating device 42 or a hearing server 44. The hearing server 44 may have a database for storing a standard data 451 and a personal data 452 and a comparing means 441. The standard data 451 may be created in advance to be stored in the database. If an environmental condition is input, the comparing means 441 may search the standard data 451 and the matching data to the input environmental condition may be transmitted to the communicating device 42. If there is no matching data in the standard data 451, the comparing means 441 may search a personal data 452 to find out a data matching to the input environmental condition. Alternatively, a personal data 452 may be produced newly. The personal data 452 may have a data corrected from the standard data 451. If there is no matching data in the database, a new personal data may be produced. The personal data may be abuse for producing the standard data 451. The common factors may be extracted from the various personal data 452 to produce the standard data 451, and the standard data 451 may be re-generated.

The personal data 452 may be produced based on a degree of the personal hearing by selection of the user. For example, the user may input a satisfaction degree of the environmental parameter correcting data applied to the hearing aid presently. Then the personal hearing data may be corrected according to the input satisfaction of the user. And the corrected final result may be applied for correcting the personal hearing data to store in the database of the personal data. The environmental condition may be input through the communicating device 42 periodically or by the selection of the user in the course of using. And the standard data 451 applying to the personal hearing data or the personal data 452 may be renewed by a data renewing unit 432 installed in the communicating device 42 or the hearing server 44.

In according to an embodiment of the present invention, the hearing of a user may be managed. The hearing server 44 may be a personal hearing change of the user. If a degree of the change is significant, the hearing condition of the user may be transmitted to a medical server 46 to inquire whether the change is an abnormality sign of an ear. And the result can be received through the communicating device 42.

The method for fitting a hearing aid may be stored in a medium installed a communicating device or a storing medium such as a flash memory as an executable software program. The process stored in the medium may be implemented in a suitable device such as a hearing aid or a smart phone. The medium may be a form of an independent chip or a part of the communicating device.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled, in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

1. A method for fitting a hearing aid as customized to an individual environmental of a user comprising:
storing various environmental parameter correcting data in accordance of effects to a hearing capacity of each different environmental in a database of a mobile device;
setting a personal hearing data;
searching an environmental parameter correcting data matching a use environmental from the database when a hearing aid is located in the use environmental; and
correcting a personal fitting data by the searched environmental parameter correcting data.

2. The method according to claim 1, wherein the environmental parameter correcting data is produced by a selection of a user based on a hearing degree of the user in various environmental conditions.

3. The method according to claim 1, wherein the environmental parameter correcting data comprises a standard data, wherein the standard data is created as a form of a gain setting applicable to any person as average value based on a personal peculiarity.

4. A system for fitting a hearing aid comprising:
A hearing compensating device;
A mobile device for communicating with the hearing compensating device;
An environment determining means for determining a factor to affect a hearing capacity from an environmental condition input thorough the mobile device or selected by a user; and
A hearing server for selecting an environmental parameter correcting data from the factor transmitted by the environment determining means to return to the mobile device,
Wherein the hearing device comprises a database containing a person data and a standard data, and the personal data is produced based on a personal hearing capacity to a noisy environment.

5. A medium for storing a method of fitting a hearing aid,
The method comprising:
storing various environmental parameter correcting data in accordance of effects to a hearing capacity of each different environmental in a database of a mobile device;
setting a personal hearing data;
searching an environmental parameter correcting data matching a use environmental from the database when a hearing aid is located in the use environmental; and
correcting a personal fitting data by the searched environmental parameter correcting data.
